(19) United States
(12) Patent Application Publication
(10) Pub. No.: US 2021/0025453 A1
(43) Pub. Date: Jan. 28, 2021

(54) SEALING STRUCTURE AND ROLLING BEARING DEVICE HAVING THE SEALING STRUCTURE

(71) Applicant: JTEKT CORPORATION, Osaka-shi, Osaka (JP)

(72) Inventor: Takafumi UEMOTO, Kashiwara-shi (JP)

(73) Assignee: JTEKT CORPORATION, Osaka-shi, Osaka (JP)

(21) Appl. No.: 16/969,027

(22) PCT Filed: Mar. 6, 2019
(86) PCT No.: PCT/JP2019/008750

§ 371 Date: Aug. 11, 2020

(30) Foreign Application Priority Data
Mar. 8, 2018 (JP) 2018-041833

(51) Int. Cl. F16C 33/78; F16C 19/18

(52) U.S. Cl. CPC F16C 33/7823; F16C 2326/02; F16C 19/184

(57) ABSTRACT

A sealing structure includes a seal member and a slinger. The seal member includes a gutter positioned between a seal fixing portion and a seal lip in an axial direction. The gutter and the seal lip are positioned at different positions in the axial direction, and a first axially extending portion radially faces a whole of the seal lip and a part of the gutter on one axial side. A communication portion communicating with an outside of the sealing structure is formed between the seal fixing portion and the first axially extending portion. The communication portion radially faces a part of the gutter on the other axial side.

### TECHNICAL FIELD

An aspect of the present invention relates to a sealing structure and a rolling bearing device having the sealing structure.

### BACKGROUND ART

In a vehicle which is an automobile or the like, a wheel bearing device (a hub unit) is used to support a wheel. The wheel bearing device includes an outer ring member attached to a vehicle body, an inner shaft member to which the wheel is attached, and a plurality of rolling elements (balls) provided between the outer ring member and the inner shaft member.

FIG. 3 illustrates a part of a related-art bearing device 2. In FIG. 3, a left-right direction is an axial direction of the bearing device 2, and an upper-lower direction is a radial direction of the bearing device 2.

As illustrated in FIG. 3, in the bearing device 2, a seal member 8 and a slinger 10 are provided between the outer ring member 4 and the inner shaft member 6. The seal member 8 is fixed to the outer ring member 4, and the slinger 10 is fixed to the inner shaft member 6.

In the bearing device 2, a communication portion 12 that communicates with an outside of the device is formed between the seal member 8 and the slinger 10, and muddy water may enter the bearing device 2 from the outside through the communication portion 12. Therefore, in order to prevent muddy water from entering the bearing device 2, the seal member 8 is provided with a seal lip 16 whose lip tip 16a is in sliding contact with a lip contact surface 14 of the slinger 10, and a gutter 18 for receiving muddy water or the like that has entered the bearing device 2 through the communication portion 12. The bearing device 2 having this sealing structure has been disclosed in, for example, Patent Literature 1 described below.

### CITATION LIST

### Patent Literature

Patent Literature 1: JP-T-2013-534301

### SUMMARY OF INVENTION

### Technical Problem

The seal lip 16 is formed of an elastic material. Therefore, the seal lip 16 (indicated by a solid line) whose lip tip 16a is in contact with the slinger 10 is elastically deformed with respect to the seal lip 16 (indicated by a two-dot chain line) before contacting the slinger 10, and a tip part 16b of the seal lip 16 approaches the gutter 18.

In the bearing device 2 illustrated in FIG. 3, the seal lip 16 and the gutter 18 are at the same position in the axial direction. Since the gutter 18 is radially outward of the seal lip 16, in the bearing device 2, a gap 20 (hereinafter also referred to as an opening portion 20) where the tip part 16b of the seal lip 16 and the gutter 18 are closest is narrow.

Roads may be flooded in rainy areas. When the wheel is immersed in muddy water, the muddy water reaches a space A between the seal lip 16 and the gutter 18. In the bearing device 2 illustrated in FIG. 3, as described above, the opening portion 20 is narrow. Therefore, it is difficult for the muddy water that has reached the space A between the seal lip 16 and the gutter 18 to be discharged.

Water contained in the muddy water evaporates. Therefore, mud may accumulate in the space A between the seal lip 16 and the gutter 18, specifically, in a root part 16c of the seal lip 16. The accumulation of mud degrades conformability of the seal lip 16. Mud may be trapped between the lip tip 16a of the seal lip 16 and the lip contact surface 14. From a viewpoint of improving a seal life, it is required to establish a technique capable of easily discharging muddy water to an outside without retaining the muddy water in the space A between the seal lip 16 and the gutter 18 even if the muddy water reaches the space A.

An aspect of the present invention has been made in view of these circumstances, and is to provide a sealing structure and a rolling bearing device having the sealing structure, in which a seal life is improved.

### Solution to Problem

A sealing structure according to an aspect of the present invention includes: a seal member and a slinger, the seal member and the slinger being positioned between a first member and a second member, the first member and the second member being configured to relatively rotate about a central axis of the first member or the second member, in which the seal member is formed in an annular shape as a whole, and the seal member includes: a seal fixing portion fixed to a seal fixation portion of the first member; and a seal lip positioned on one axial side relative to the seal fixing portion, the seal lip being formed of an elastic material, in which the slinger is formed in an annular shape as a whole, and the slinger includes: a slinger fixing portion fixed to a slinger fixation portion of the second member; a lip contact surface with which a lip tip of the seal lip is in sliding contact; and a first axially extending portion disposed radially outward of the seal lip and extending from the one axial side toward the other axial side, in which the seal member includes a gutter positioned between the seal fixing portion and the seal lip in an axial direction, in which the gutter and the seal lip are positioned at different positions in the axial direction, and the first axially extending portion radially faces a whole of the seal lip and a part of the gutter on the one axial side, in which a communication portion communicating with an outside of the sealing structure is formed between the seal fixing portion and the first axially extending portion, and in which the communication portion radially faces a part of the gutter on the other axial side.

In the sealing structure according to the aspect of the present invention, the communication portion radially faces the gutter. Therefore, muddy water accumulated in the gutter is easily discharged to the outside through the communication portion.

In the sealing structure, the gutter and the seal lip are positioned at different positions in the axial direction. The seal lip is not radially inward of the gutter but on the one axial side of the gutter, so that even if the lip tip of the seal lip comes into contact with the seal contact surface of the slinger and is elastically deformed, a sufficient distance is secured between the tip part of the seal lip and the gutter. In this sealing structure, the opening portion is wider than that of the related-art sealing structure, so that even if muddy water overflows the gutter and reaches a space between the seal lip and the gutter, the muddy water is easily discharged to the outside without being retained in this space.

According to this sealing structure, accumulation of mud on the root part of the seal lip, which has been a concern in related-art sealing structure, is prevented. Conformability of the seal lip is appropriately maintained, and mud is also prevented from being trapped between the seal lip and the seal contact surface. This sealing structure contributes to an improvement in seal life.

Preferably, in this sealing structure, the slinger includes a radially extending portion, and the radially extending portion extends radially outward from an end of the first axially extending portion on the other axial side, and a space between the radially extending portion and the seal fixing portion serves as the communication portion. With this configuration, muddy water is more effectively discharged through the communication portion.

Preferably, in this sealing structure, the slinger includes a second axially extending portion, and the second axially extending portion extends from an outer end of the radially extending portion toward the other axial side. With this configuration, a length of the communication portion is sufficiently ensured. The long communication portion contributes to preventing muddy water from entering this sealing structure.

A rolling bearing device according to the aspect of the present invention includes: an inner shaft member; an outer ring member; a plurality of rolling elements rotatably provided between the inner shaft member and the outer ring member; and the above-described sealing structure, in which any one of the inner shaft member and the outer ring member is the first member, and the other of the inner shaft member and the outer ring member is the second member.

The rolling bearing device according to the aspect of the present invention has the above-described sealing structure, so that even if muddy water overflows the gutter and reaches a space between the seal lip and the gutter, the muddy water is easily discharged to the outside without being retained in this space. In this rolling bearing device, mud is prevented from being accumulated on the root part of the seal lip, so that conformability of the seal lip is appropriately maintained, and mud is also prevented from being trapped between the lip tip of the seal lip and the seal contact surface. According to this rolling bearing device, a seal life is improved.

### Advantageous Effects of Invention

As is clear from the above description, in the sealing structure and the rolling bearing device having the sealing structure according to the aspect of the present invention, a seal life is improved.

### BRIEF DESCRIPTION OF DRAWINGS

FIG. 1 is a cross-sectional view illustrating an example of a rolling bearing device having a sealing structure according to an embodiment of the present invention.

FIG. 2 is an enlarged cross-sectional view illustrating a part of the rolling bearing device in FIG. 1.

FIG. 3 is an enlarged cross-sectional view illustrating a part of a rolling bearing device having a related-art sealing structure.

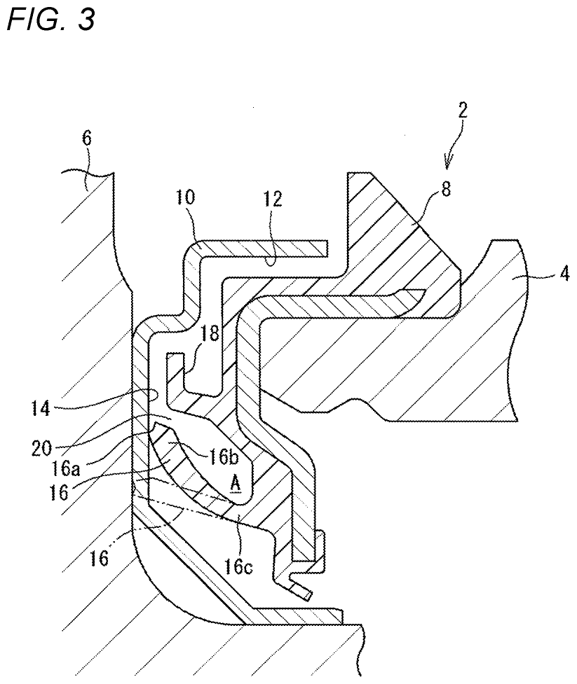

### DESCRIPTION OF EMBODIMENTS

Hereinafter, the present invention will be described in detail based on a preferred embodiment with reference to the drawings as appropriate.

[Rolling Bearing Device]

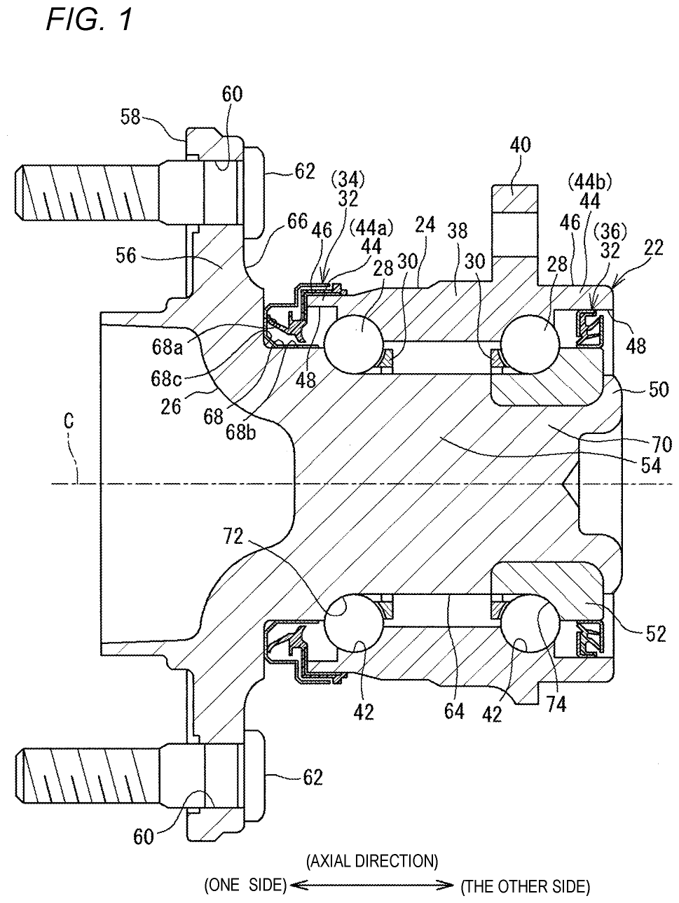

FIG. 1 illustrates an example of a wheel bearing device 22 (a hub unit) as a rolling bearing device according to an embodiment of the present invention.

The wheel bearing device 22 (hereinafter also referred to as a bearing device 22) is attached to a suspension device (also referred to as a knuckle) of a vehicle (an automobile) on a vehicle body side of the vehicle, and is configured to rotatably support a wheel. In FIG. 1, a left side of the drawing is a wheel side, that is, a vehicle outer side, and a right side of the drawing is the vehicle body side, that is, a vehicle inner side. In the present specification, in the following description, the vehicle outer side may be referred to as one axial side, and the vehicle inner side may be referred to as the other axial side for convenience of description.

The bearing device 22 includes an outer ring member 24 as a first member, an inner shaft member 26 as a second member, a rolling element 28, a cage 30, and a pair of sealing members 32. In the present specification, of the pair of sealing members 32, the sealing member 32 provided on the one axial side is referred to as an outer sealing member 34, and the sealing member 32 provided on the other axial side is referred to as an inner sealing member 36.

In the bearing device 22, the axial direction is parallel to a central axis C (hereinafter referred to as a bearing central axis C) of the bearing device 22. A radial direction is orthogonal to the axial direction. Therefore, in FIG. 1, a left-right direction is the axial direction of the bearing device 22, and an upper-lower direction is the radial direction of the bearing device 22.

In the bearing device 22, the inner shaft member 26 is rotated about the bearing central axis C relative to the outer ring member 24. In the bearing device 22, the outer ring member 24 and the inner shaft member 26 may be relatively rotated about the bearing central axis C, and depending on an application in which the bearing device 22 is used, the bearing device 22 may be provided such that the outer ring member 24 is rotated about the bearing central axis C relative to the inner shaft member 26.

The outer ring member 24 includes an outer ring body 38 having a cylindrical shape and a flange portion 40 extending radially outward from the outer ring body 38. In the outer ring member 24, an outer ring raceway surface 42 is formed on an inner peripheral side of the outer ring body 38. The outer ring member 24 is attached to a knuckle (not illustrated), which is a vehicle body side member, by the flange portion 40. Accordingly, the bearing device 22 including the outer ring member 24 is fixed to a vehicle body.

In the outer ring member 24, a ring portion 44 is provided on each of the one axial side of the outer ring body 38 and the other axial side of the outer ring body 38. The ring portion 44 has a ring shape and includes an outer peripheral surface 46 and an inner peripheral surface 48. In the bearing device 22, a ring portion 44a on one axial side is referred to as an outer ring portion 44a, and a ring portion 44b on the other axial side is referred to as an inner ring portion 44b.

The inner shaft member 26 includes a rod-shaped hub shaft 50 (an inner shaft) and an inner ring 52 attached to the other axial side of the hub shaft 50. The hub shaft 50 includes a shaft body 54 provided radially inward of the outer ring member 24 and a flange portion 56 provided on the one axial side of the shaft body 54. The shaft body 54 is a shaft portion that is long in the axial direction. The flange portion 56 extends radially outward from the one axial side of the shaft body 54.

In the inner shaft member 26, the flange portion 56 includes an outer surface 58 (a flange surface) on the one axial side, and is formed with a bolt hole 60 penetrating the flange portion 56 in the axial direction. Although not illustrated, a brake rotor is attached to the outer surface 58. A bolt 62 configured to attach a wheel (not illustrated) and the brake rotor is attached to the bolt hole 60 by being press-fitted.

In the inner shaft member 26, a mount surface 68 is provided on an end of the outer peripheral surface 64 of the shaft body 54 on the one axial side and a radially inner end of the inner surface 66 of the flange portion 56 on the other axial side. In the bearing device 22, the outer sealing member 34 is attached to the mount surface 68. The mount surface 68 includes an annular mount surface 68a, a cylindrical mount surface 68b, and a rounded surface 68c. The annular mounting surface 68a is along a surface orthogonal to the bearing central axis C as a whole. The annular mounting surface 68a is a part of the inner surface 66 of the flange portion 56. The cylindrical mount surface 68b is along a circumferential surface parallel to the bearing central axis C as a whole. The cylindrical mount surface 68b is a part of the outer peripheral surface 64 of the shaft body 54. The rounded surface 68c connects the annular mount surface 68a and the cylindrical mount surface 68b.

In the inner shaft member 26, the inner ring 52 is an annular member, and is externally fitted and fixed to the small-diameter part 70 of the shaft body 54 on the other axial side.

In the inner shaft member 26, an axial raceway surface 72 is formed on the outer peripheral surface 64 of the shaft body 54, and an inner ring raceway surface 74 is formed on an outer peripheral surface of the inner ring 52.

In the bearing device 22, a plurality of balls, which are the rolling elements 28, are provided between the outer ring raceway surface 42 and the axial raceway surface 72 on the one axial side. A plurality of balls which are the rolling elements 28 are provided between the outer ring raceway surface 42 and the inner ring raceway surface 74 on the other axial side. The rolling elements 28 (the balls) are provided in two rows between the outer ring member 24 and the inner shaft member 26.

The inner sealing member 36 is between the inner peripheral surface 48 of the inner ring portion 44b of the outer ring member 24 and the outer peripheral surface of the inner ring 52 of the inner shaft member 26 on the other axial side. The inner sealing member 36 prevents foreign matter which is muddy water or the like from entering the bearing device 22.

The outer sealing member 34 is between the outer ring portion 44a of the outer ring member 24 and the mount surface 68 of the inner shaft member 26 on the one axial side. As with the above-described inner sealing member 36, the outer sealing member 34 also prevents foreign matter which is muddy water or the like from entering the bearing device 22. The outer sealing member 34 will be described in detail below.

[Outer Sealing Member 34]

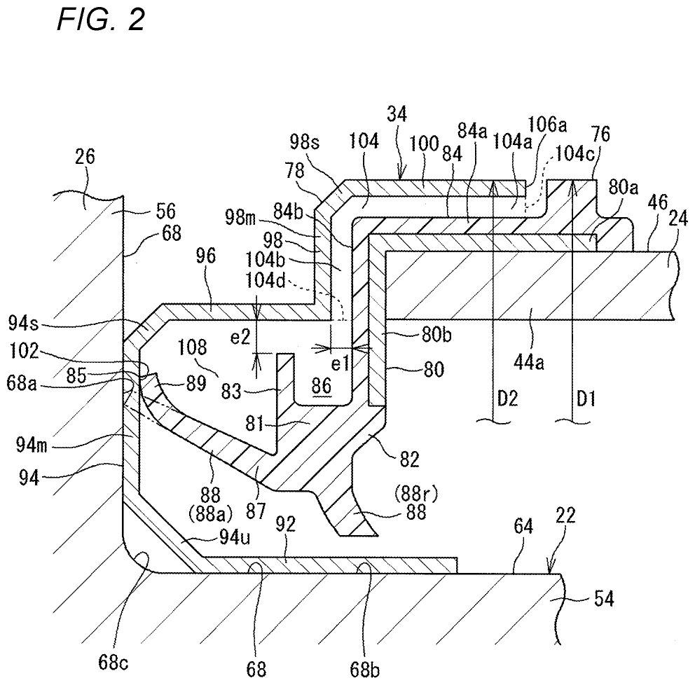

FIG. 2 illustrates a part of the bearing device 22 in FIG. 1. In FIG. 2, a part of the outer sealing member 34 is illustrated.

In the bearing device 22, the outer sealing member 34 includes a seal member 76 and a slinger 78. The seal member 76 and the slinger 78 are between the outer ring member 24 which is the first member and the inner shaft member 26 which is the second member.

In FIG. 2, a double-headed arrow D1 is an outer diameter of the seal member 76, and a double-headed arrow D2 is an outer diameter of the slinger 78. In the bearing device 22, the seal member 76 and the slinger 78 are provided such that the outer diameter D1 and the outer diameter D2 are equal to each other.

The seal member 76 is formed in an annular shape as a whole. The seal member 76 includes an annular metal ring 80 having a substantially L-shaped cross section and an elastic member 82 fixed to the metal ring 80. The seal member 76 includes the metal ring 80 and the elastic member 82.

The metal ring 80 is an annular member formed of metal (for example, SPCC). The metal ring 80 includes a cylindrical part 80a having a cylindrical shape and an annular plate part 80b having an annular shape. An axial center of the cylindrical part 80a coincides with the bearing central axis C. The annular plate part 80b extends radially inward from an end of the cylindrical part 80a on the one axial side.

The elastic member 82 is formed of an elastic material whose base rubber is synthetic rubber (for example, acrylonitrile-butadiene rubber (NBR) and acrylic rubber (ACM)). The elastic member 82 is fixed to the metal ring 80 by adhesive processing (also referred to as baking) by performing vulcanization.

The seal member 76 is fixed to the outer ring portion 44a of the outer ring member 24. In the bearing device 22, the outer ring member 24 which is a first member includes the outer ring portion 44a as a seal fixation portion configured to fix the seal member 76.

The seal member 76 includes a seal fixing portion 84, a base portion 81, a wall 83, and two seal lips 88. Of these seal lips 88, a seal lip 88r on a radially inner side of the seal member 76 is referred to as a radial lip, and a seal lip 88a on the one axial side of the seal member 76 is referred to as an axial lip.

The seal fixing portion 84 is on the other axial side of the seal member 76. In the bearing device 22, the seal member 76 is fixed to the outer ring portion 44a which is the seal fixation portion in the seal fixing portion 84. The seal member 76 includes the seal fixing portion 84 that is fixed to the seal fixation portion.

The seal fixing portion 84 includes the elastic member 82 and the metal ring 80. The seal fixing portion 84 has a substantially L-shaped cross section along the metal ring 80. The seal fixing portion 84 includes a cylindrical part 84a having a cylindrical shape and an annular plate part 84b having an annular shape. The cylindrical part 84a extends in the axial direction. An axial center of the cylindrical part 84a coincides with the bearing central axis C. The annular plate part 84b extends radially inward from an end of the cylindrical part 84a on the one axial side in the radial direction.

In the bearing device 22, the seal fixing portion 84 is externally fitted to the outer ring portion 44a such that the cylindrical part 84a of the seal fixing portion 84, specifically, the cylindrical part 80a of the metal ring 80 presses the outer peripheral surface 46 of the outer ring portion 44a. Accordingly, in the bearing device 22, the seal fixing portion 84 of the seal member 76 is fixed to the outer peripheral surface 46 of the outer ring portion 44a.

The base portion 81 includes the elastic member 82. The base portion 81 is radially inward of the seal fixing portion 84. The base portion 81 extends from the seal fixing portion 84 in the one axial direction.

The wall 83 includes the elastic member 82. The wall 83 extends radially outward from an end of the base portion 81 on the one axial side.

In the seal member 76, a space surrounded by a surface of the seal fixing portion 84 on the one axial side, an outer peripheral surface of the base portion 81, and a surface of the wall 83 on the other axial side is a gutter 86. That is, the seal member 76 is formed with the gutter 86 surrounded by the surface of the seal fixing portion 84 on the one axial side, the outer peripheral surface of the base portion 81, and the surface of the wall 83 on the other axial side.

The radial lip 88r includes the elastic member 82. The radial lip 88r is radially inward of the gutter 86. The radial lip 88r protrudes radially inward from the base portion 81. The radial lip 88r prevents grease filled in the bearing device 22 from leaking to an outside.

The axial lip 88a includes the elastic member 82. The axial lip 88a is on the one axial side with respect to the seal fixing portion 84 and the wall 83. As illustrated in FIG. 2, the axial lip 88a protrudes from the base portion 81 to the one axial side. The axial lip 88a extends from a radially inner part of the base portion 81 toward the one axial side while increasing in diameter.

The slinger 78 is formed in an annular shape as a whole. The slinger 78 is an annular member formed of metal (for example, SUS304). The slinger 78 is fixed to the mount surface 68 of the inner shaft member 26. In the bearing device 22, the inner shaft member 26 which is the second member includes the mount surface 68 as a slinger fixation portion configured to fix the slinger 78.

As described above, the mount surface 68 includes the cylindrical mount surface 68b. The cylindrical mount surface 68b is the outer peripheral surface 64 of the shaft body 54.

The slinger 78 includes a cylindrical slinger fixing portion 92, a disk-shaped first radially extending portion 94, a cylindrical first axially extending portion 96, a disk-shaped second radially extending portion 98, and a cylindrical second axially extending portion 100.

The slinger fixing portion 92 is on a radially inner side of the slinger 78. The slinger fixing portion 92 extends in the axial direction. In the bearing device 22, the slinger 78 is fixed to the cylindrical mount surface 68b which is the slinger fixation portion in the slinger fixing portion 92. The slinger 78 includes a slinger fixing portion 92 that is fixed to the slinger fixation portion.

In the bearing device 22, the slinger fixing portion 92 is externally fitted to the shaft body 54 such that the slinger fixing portion 92 presses the cylindrical mount surface 68b. Accordingly, in the bearing device 22, the slinger fixing portion 92 of the slinger 78 is fixed to the cylindrical mount surface 68b.

In the bearing device 22, the first radially extending portion 94 is on the one axial side with respect to the slinger fixing portion 92. In the bearing device 22, the first radially extending portion 94 includes a body part 94m, a connection member 94u radially inward of the body part 94m, and a connection member 94s radially outward of the body part 94m. As illustrated in FIG. 2, the first radially extending portion 94 is connected to the slinger fixing portion 92 at the connection member 94u. The body part 94m of the first radially extending portion 94 extends radially outward from an end of the connection member 94u on the one axial side.

In the bearing device 22, the body part 94m of the first radially extending portion 94 abuts against the annular mounting surface 68a. As illustrated in FIG. 2, the first radially extending portion 94, specifically, an inner surface 102 of the body part 94m on the other axial side, is in contact with a lip tip 85 of the axial lip 88a. In the bearing device 22, the inner surface 102 is a lip contact surface with which the lip tip 85 of the axial lip 88a is in sliding contact. The first radially extending portion 94 of the slinger 78 includes the lip contact surface 102 with which the lip tip 85 of the axial lip 88a is in sliding contact.

In the bearing device 22, the seal member 76 is provided with respect to the slinger 78 in consideration of a tightening margin. Therefore, since the lip tip 85 of the axial lip 88a comes into contact with the lip contact surface 102, a tip part 89 of the axial lip 88a is elastically deformed.

In the bearing device 22, the first axially extending portion 96 is on the other axial side with respect to the first radially extending portion 94. In the bearing device 22, the first axially extending portion 96 is connected to the first radially extending portion 94 at the connection member 94s of the first radially extending portion 94. In the bearing device 22, the first axially extending portion 96 may be connected to the first radially extending portion 94 without providing the connection member 94s on the first radially extending portion 94. As illustrated in FIG. 2, the first axially extending portion 96 is radially outward of the axial lip 88a, and extends from an outer end of the first radially extending portion 94 in the axial direction from the one axial side toward the other axial side.

The second radially extending portion 98 is radially outward of the first axially extending portion 96. In the bearing device 22, the second radially extending portion 98 includes a body part 98m and a connection member 98s radially outward of the body part 98m. As illustrated in FIG. 2, in the bearing device 22, the second radially extending portion 98 is on the one axial side with respect to the annular plate part 84b of the seal fixing portion 84. The second radially extending portion 98, specifically, the body part 98m of the second radially extending portion 98 extends radially outward from an end of the first axially extending portion 96 on the other axial side.

The second axially extending portion 100 is on the other axial side with respect to the second radially extending portion 98. In the bearing device 22, the second axially extending portion 100 is connected to the second radially extending portion 98 at the connection member 98s of the second radially extending portion 98. In the bearing device 22, the second axially extending portion 100 may be connected to the second radially extending portion 98 without providing the connection member 98s on the second radially extending portion 98. As illustrated in FIG. 2, the second axially extending portion 100 is radially outward of the cylindrical part 84a of the seal fixing portion 84, and extends from an outer end of the second radially extending portion 98 in the axial direction from the one axial side toward the other axial side.

In the bearing device 22, the outer sealing member 34, that is, the seal member 76 and the slinger 78 constitute the sealing structure according to the embodiment of the present invention. That is, the bearing device 22 has the sealing structure including the seal member 76 and the slinger 78. The sealing structure will be described in detail below. The inner sealing member 36 may have the sealing structure according to the embodiment of the present invention.

In this sealing structure, a communication portion 104 is provided as a gap between the seal fixing portion 84 of the seal member 76 and the slinger 78. In this sealing structure, the communication portion 104 includes an axial communication portion 104a between the cylindrical part 84a of the seal fixing portion 84 and the second axially extending portion 100, and a radial communication portion 104b between the annular plate part 84b of the seal fixing portion 84 and the second radially extending portion 98. In this sealing structure, the axial communication portion 104a and the radial communication portion 104b have substantially the same size.

The communication portion 104 communicates an outside and an inside of the sealing structure. In this sealing structure, a position the same as that of the other axial end part 106a of the second axially extending portion 100 is an outer end 104c of the communication portion 104. A space between the first axially extending portion 96 and the annular plate part 84b of the seal fixing portion 84 is an inner end 104d of the communication portion 104.

In this sealing structure, a size of the communication portion 104 is adjusted such that foreign matter (hereinafter simply referred to as muddy water) which is muddy water or the like is not likely to enter this sealing structure from the outside. However, muddy water cannot be completely prevented from entering this sealing structure from the outside, and may enter this sealing structure from the outside through the communication portion 104.

This sealing structure is characterized in that the seal member 76 includes the gutter 86 between the seal fixing portion 84 and the axial lip 88a in the axial direction, that the gutter 86 is at a position axially different from the axial lip 88a in the radial direction, that the first axially extending portion 96 radially faces the entire axial lip 88a and a part of the gutter 86 on the one axial side, and that the communication portion 104, specifically, the inner end 104d of the communication portion 104 radially faces a part of the gutter 86 on the other axial side.

In this sealing structure, the communication portion 104 radially faces the gutter 86. Therefore, muddy water that has entered the inside through the communication portion 104 is likely to be received by the gutter 86, and the muddy water accumulated in the gutter 86 is easily discharged to the outside through the communication portion 104.

In the sealing structure, the gutter portion 86 is at a position different from that of the axial lip 88a in the axial direction. The axial lip 88a is on the one axial side of the gutter 86, so that even if the lip tip 85 of the axial lip 88a comes into contact with the lip contact surface 102 of the slinger 78 and is elastically deformed, a sufficient distance is secured between the tip part 89 of the axial lip 88a and the gutter 86. In this sealing structure, the opening portion 108 is wider than that of the related-art sealing structure, so that even if muddy water overflows the gutter 86 and reaches a space between the axial lip 88a and the gutter 86, the muddy water is easily discharged to the outside without being retained in this space.

According to this sealing structure, accumulation of mud on the root part 87 of the axial lip 88a, which has been a concern in related-art sealing structure, is prevented. Conformability of the axial lip 88a is appropriately maintained, and mud is also prevented from being trapped between the lip tip 85 of the axial lip 88a and the lip contact surface 102. This sealing structure contributes to an improvement in seal life.

In this sealing structure, the communication portion 104 includes the radial communication portion 104b. The radial communication portion 104b faces the part of the gutter 86 on the other axial side, which contributes to the discharge of muddy water through the communication portion 104. From this viewpoint, in this sealing structure, it is preferable that the slinger 78 includes the disk-shaped second radially extending portion 98 extending in the radial direction, that the second radially extending portion 98 extends radially outward from the end of the first axially extending portion 96 on the other axial side, and that the communication portion 104 is provided between the second radially extending portion 98 and the seal fixing portion 84.

In this sealing structure, the axial communication portion 104a is provided, so that a length of the communication portion 104 is sufficiently ensured. The long communication portion 104 contributes to preventing muddy water from entering this sealing structure. From this viewpoint, in this sealing structure, it is preferable that the slinger 78 includes a cylindrical second axially extending portion 100 extending in the axial direction, and that the second axially extending portion 100 extends from the outer end of the second radially extending portion 98 toward the other axial side.

In FIG. 2, a double-headed arrow e1 represents the size of the communication portion 104 at the inner end 104d of the communication portion 104. A double-headed arrow e2 represents a size of a gap between the wall 83 of the gutter 86 and the first axially extending portion 96.

In this sealing structure, the size e1 of the communication portion 104 may be equal to the size e2 of the gap, the size e1 of the communication portion 104 may be larger than the size e2 of the gap, or the size e1 of the communication portion 104 may be smaller than the size e2 of the gap. From a viewpoint of effective discharging of muddy water, in the sealing structure, it is preferable that the size e1 of the communication portion 104 is equal to the size e2 of the gap, or the size e1 of the communication portion 104 is larger than the size e2 of the gap.

In terms of the sealing structure and the bearing device 22 having the sealing structure according to the embodiment of the present invention, the bearing device 22 has been described in which the outer ring member 24 is the first member to which the seal member 76 is fixed and the inner shaft member 26 is the second member to which the slinger 78 is fixed. However, according to a rolling device in which the outer ring member 24 is the second member to which the slinger 78 is fixed and the inner shaft member 26 is the first member to which the seal member 76 is fixed, mud is prevented from being accumulated, and a seal life is improved.

As is clear from the above description, in the sealing structure and the bearing device 22 having the sealing structure according to the embodiment of the present invention, the seal life is improved.

The embodiment disclosed herein is to exemplify the present invention in every point and is not intended to restrict the present invention. The technical scope of the present invention is not limited to the above embodiment, and all modifications within a scope equivalent to the configurations described in the claims are included in the technical scope.

The present application is based on Japanese Patent Application (Application No. 2018-041833) filed on Mar. 8, 2018, the contents of which are incorporated herein by reference.

### REFERENCE SIGNS LIST

2, 22: bearing device

4, 24: outer ring member

6, 26: inner shaft member

8, 76: seal member

10, 78: slinger

12: communication portion

14: lip contact surface

16: seal lip

16a: lip tip

16b: tip part

16c: root part

18: gutter

20, 108: opening portion

28: rolling element

30: cage

32: sealing member

34: outer sealing member

36: inner sealing member

38: outer ring body

40: flange portion

42: outer ring raceway surface

44: ring portion

44a: outer ring portion

44b: inner ring portion

46: outer peripheral surface of ring portion 44

48: inner peripheral surface of ring portion 44

50: hub shaft

52: inner ring

54: shaft body

56: flange portion

58: outer surface of flange portion 56

60: bolt hole

62: bolt

64: outer peripheral surface of shaft body 54

66: inner surface of flange portion 56

68: mount surface

68a: annular mount surface

68b: cylindrical mount surface

68c: rounded surface

70: small-diameter part of shaft body 54

72: axial raceway surface

74: inner ring raceway surface

80: metal ring

80a: cylindrical part of metal ring 80

80b: annular plate part of metal ring 80

81: base portion

82: elastic member

83: wall

84: seal fixing portion

84a: cylindrical part of seal fixing portion 84

84b: annular plate part of seal fixing portion 84

85: lip tip

86: gutter

87: root part

88: seal lip

88r: seal lip (radial lip)

88a: seal lip (axial lip)

89: tip part

92: slinger fixing portion

94: first radially extending portion

94m: body part of first radially extending portion 94

94u: connection member of first radially extending portion 94

94s: connection member of first radially extending portion 94

96: first axially extending portion

98: second radially extending portion

98m: body part of second radially extending portion 98

98s: connection member of second radially extending portion 98

100: second axially extending portion

102: inner surface (lip contact surface) of body part 94m of first radially extending portion 94

104: communication portion

104a: axial communication portion

104b: radial communication portion

104c: outer end of communication portion 104

104d: inner end of communication portion 104

106a: the other axial end part of second axially extending portion 100

1. A sealing structure comprising:
a seal member and a slinger, the seal member and the slinger being positioned between a first member and a second member, the first member and the second member being configured to relatively rotate about a central axis of the first member or the second member,
wherein the seal member is formed in an annular shape as a whole, and the seal member comprises: a seal fixing portion fixed to a seal fixation portion of the first member; and a seal lip positioned on one axial side relative to the seal fixing portion, the seal lip being formed of an elastic material,
wherein the slinger is formed in an annular shape as a whole, and the slinger comprises: a slinger fixing portion fixed to a slinger fixation portion of the second member; a lip contact surface with which a lip tip of the seal lip is in sliding contact; and a first axially extending portion disposed radially outward of the seal lip and extending from the one axial side toward the other axial side,
wherein the seal member comprises a gutter positioned between the seal fixing portion and the seal lip in an axial direction,
wherein the gutter and the seal lip are positioned at different positions in the axial direction, and the first axially extending portion radially faces a whole of the seal lip and a part of the gutter on the one axial side,
wherein a communication portion communicating with an outside of the sealing structure is formed between the seal fixing portion and the first axially extending portion, and
wherein the communication portion radially faces a part of the gutter on the other axial side.

2. The sealing structure according to claim 1,
wherein the slinger comprises a radially extending portion, and the radially extending portion extends radially outward from an end of the first axially extending portion on the other axial side, and
wherein a space between the radially extending portion and the seal fixing portion serves as the communication portion.

3. The sealing structure according to claim 2,
wherein the slinger comprises a second axially extending portion, and the second axially extending portion extends from an outer end of the radially extending portion toward the other axial side.

4. A rolling bearing device comprising:
an inner shaft member;
an outer ring member;
a plurality of rolling elements rotatably provided between the inner shaft member and the outer ring member; and
the sealing structure according to claim 1,
wherein any one of the inner shaft member and the outer ring member is the first member, and the other of the inner shaft member and the outer ring member is the second member.
